(19) United States
(12) Patent Application Publication
(10) Pub. No.: US 2014/0173991 A1
(43) Pub. Date: Jun. 26, 2014

(54) SLIDING DOOR WITH RAMP

(71) Applicant: MILGARD MANUFACTURING INCORPORATED, Taylor, MI (US)

(72) Inventors: Melvin Saunders, Auburn, WA (US); Victor Massey, Orting, WA (US)

(73) Assignee: Milgard Manufacturing Incorporated, Taylor, MI (US)

(21) Appl. No.: 13/725,142

(22) Filed: Dec. 21, 2012

(51) Int. Cl. E05D 15/06; E06B 7/18

(52) U.S. Cl. CPC E05D 15/0652; E06B 7/18
USPC 49/411; 49/489.1; 49/480.1

(57) ABSTRACT

A sliding door includes slidable panel. A first weather stripping member is secured to a portion of the slidable panel. A header and a sill each include a track having a length defining a longitudinal axis. At least one of the tracks includes a first ramp and a second ramp spaced from the first ramp along the longitudinal axis. The slidable panel moves along the longitudinal axis from an open position to a closed position. The slidable panel is moved from a lowered position to a raised position on both the first ramp and second ramp as the slidable panel is moved to the closed position. The weather stripping member is engaged against one of either the header or sill when the slidable panel is in the raised and closed position. The weather stripping is disengaged from the header or sill when the slidable panel is the lowered and open position.

### CROSS-REFERENCE TO RELATED PATENT APPLICATIONS

None.

### BACKGROUND

The present invention relates generally to the field of sliding door and/or window assemblies and more particularly, to a sliding door/window with weather stripping. Sliding doors are used to provide ingress and egress from a building structure. Weather stripping is used to provide a weather tight barrier between the sliding door and a door frame. Weather stripping is typically located between the frame of a sliding door and a header and/or sill.

### SUMMARY

A sliding door includes slidable panel. A first weather stripping member is secured to a portion of the slidable panel. A header and a sill include a track having a length defining a longitudinal axis. The track includes a first ramp and a second ramp spaced from the first ramp along the longitudinal axis. The slidable panel moves along the longitudinal axis from an open position to a closed position. The slidable panel is moved from a lowered position to a raised position on both the first ramp and second ramp as the slidable panel is moved to the closed position. The weather stripping is engaged against one of either the header or sill when the slidable panel is in the raised and closed position. The weather stripping is disengaged from the header or sill when the slidable panel is the lowered and open position.

In another embodiment, a sliding barrier apparatus includes a barrier including a sliding panel and a first weather strip and a second weather strip. A first rail is spaced from and parallel to a second rail. The sliding panel includes a first side and a second side sliding respectively within the first rail and second rail. The first rail includes a longitudinal axis and has a first incline and a second incline spaced apart from the first incline along the longitudinal axis. The first incline and second incline has a raised portion extending toward the second rail. The sliding panel slides within the first rail and second rail from an open position to a closed position. The sliding panel moves toward the second rail by the first and second incline in the closed position.

### BRIEF DESCRIPTION OF THE DRAWINGS

FIG. 1 is a view of a sliding door assembly in an open configuration.

FIG. 2 is a view of the sliding door assembly of FIG. 1 in the closed configuration.

FIG. 3 is a cross-sectional view of the sliding door assembly of FIG. 1 taken generally along line 3-3.

FIG. 4 is a cross-sectional view of the sliding door assembly of FIG. 2 taken generally along line 4-4.

FIG. 5 is a close up of view of a portion of the cross-sectional view of FIG. 3 taken generally along line 5-5.

FIG. 6 is a close up of view of a portion of the cross-sectional view of FIG. 4 taken generally along line 6-6.

FIG. 7 is cross-sectional view of an alternative embodiment of a sliding panel in an open position with weather stripping on the header and sill.

FIG. 8 is cross-sectional view of an alternative embodiment of a sliding panel in a closed position with weather stripping on the header and sill.

### DETAILED DESCRIPTION OF THE EXAMPLE EMBODIMENTS

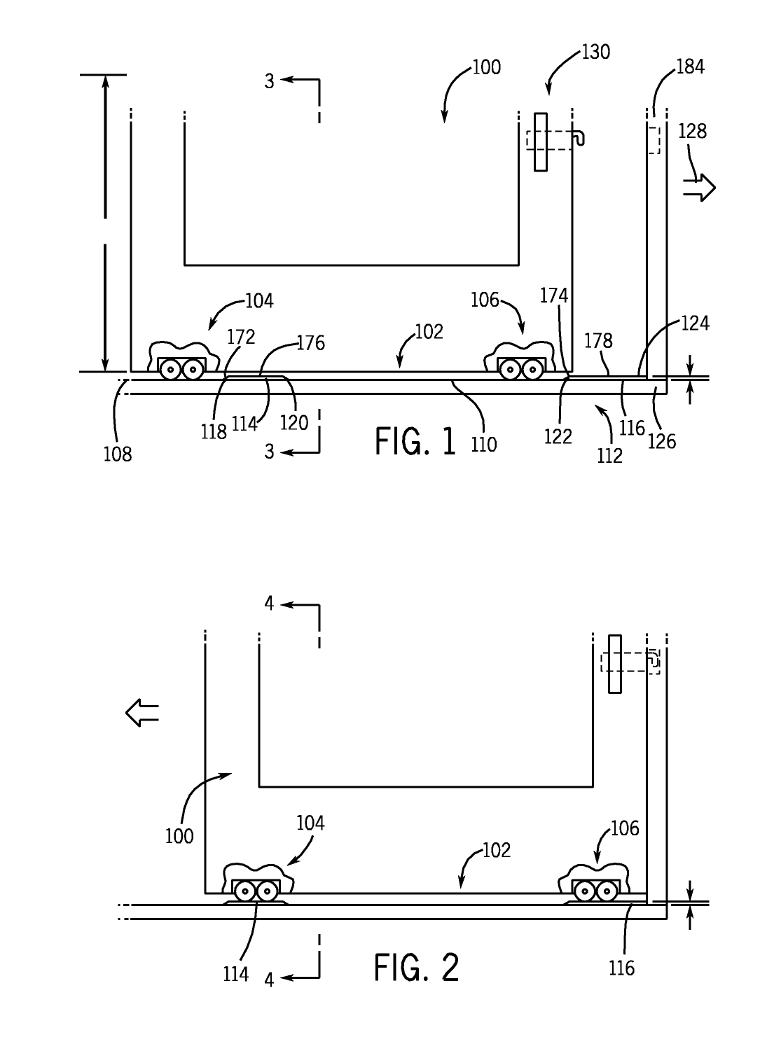

FIG. 1 shows a front view of a bottom half of a door panel 100 in an open position. At the bottom portion 102 of the door panel 100 is a first set of rollers 104 and a second set of rollers 106. Both sets of rollers 104, 106 are attached to the door panel 100. Also, both set of rollers 104, 106 ride along a track 108. The track 108 is attached permanently to the top portion 110 of a sill 112. Attached to the track 108 there is a first ramp 114 and a second ramp 116. Both ramps 114, 116 are approximately a quarter of an inch high, however other ramp heights may also be used. The first ramp 114 has an approximately 45° angle inclines on both ends 118, 120 of the ramp 114. The first ramp 114 is approximately 8 inches long. The second ramp 116 has an approximately 45° angle inclined on one end 122. The other end 124 of the second ramp 116 embraces the end 126 of the sill 112. The second ramp 116 is approximately 8 inches long. However, ramps 114 and 116 may be other lengths as well.

When the door panel 100 is in an open position the two ramps 114, 116 do not play a role. The door panel 100 is free to be slid in a right horizontal position or a left horizontal position depending on the amount of outside exposure an operator of the door panel 100 wishes.

An operator can close the door panel 100 by applying a force in a vector direction 128 to a handle 130 attached to the door panel 100. In this embodiment, the door panel 100 becomes closed when the door handle 130 of the door panel 100 is slid horizontally to the right as shown in FIG. 2.

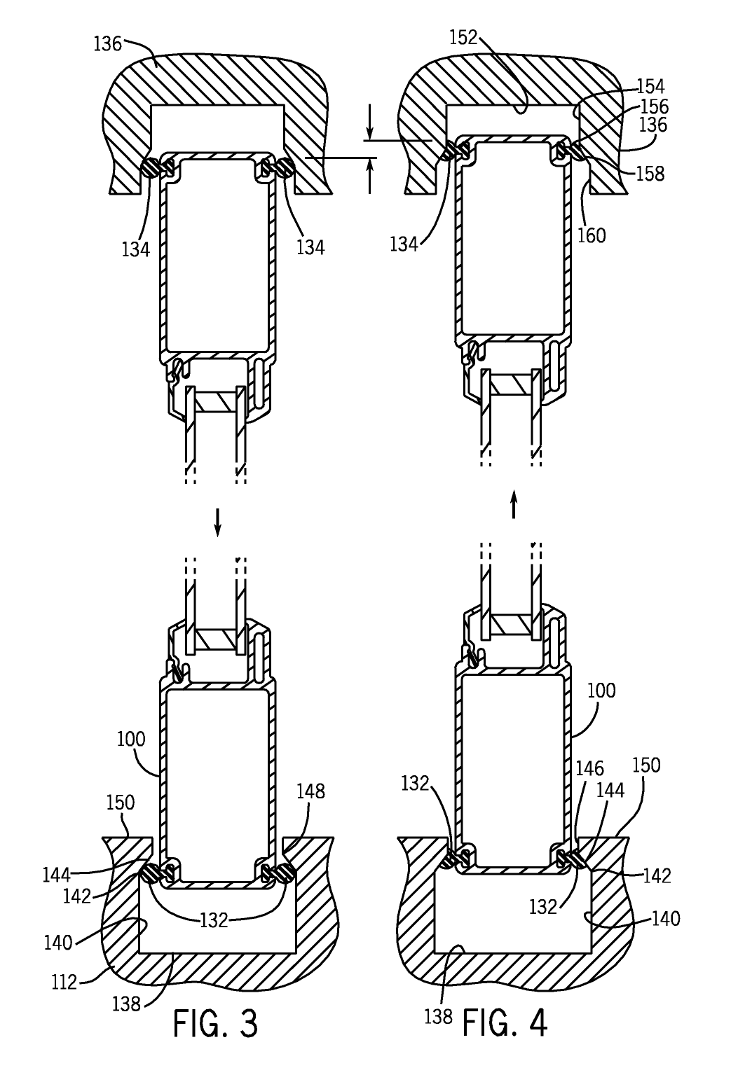

FIG. 3 shows the side view of the door panel 100. Weather strips 132 are located near the sill 112 of door panel 100 and weather strips 134 are located near the header 136 when door panel 100 is in the open position. Both the sill 112 and the header 136 serve to guide the door panel 100 as well as provide properly timed contact with all weather strips 132, 134.

FIGS. 3-6 show the sill 112 has a base 138 that is slightly wider than the door panel 100. The sill 112 has a wall 140 on each side of the base 138. Both walls 140 are approximately 90° to the base 138. Attached to the top 142 of each wall 140 is a second set of walls 144. The second set of walls 144 bend inward towards the door panel 100 at approximately 45° angle. The size or length of each wall 144 is approximately the width the weather strip 132. The sill 112 comprises a third set of walls 146. These walls 146 are connected to the top portion 148 of the second set of walls 144. The third set of walls 146 bend away from the door panel 100, such that the third set of walls 146 are parallel the first set of walls 140. Connected to the third set of walls 146 is a tail 150. Each tail 150 bends away from the door panel 100 and is approximately 90° to the third set of walls 146.

FIGS. 3-6 show the header 136 is similar in configuration to the sill 112. The significant difference is that the header 136 is upside down with respect to the sill 112. The header 136 has a base 152 that is also slightly wider than the door panel 100. The header 136 has a wall 154 on each side of the base to 10 approximately 90° to the base 152. Attached to the bottom 156 of each wall 154 is a second set of walls 158. The second set of walls 158 bend outward away from the door panel 100 (note that this is opposite of the sill 112, which bent inward). The second set of walls 158 bend outward at approximately 45° angle. The size or length of each wall 158 is approximately the width of the weather strip 134. The header 136 comprises a third set of walls 160. The third set of walls 160 are connected to the bottom portion 162 of the second set of walls 158. The third set of walls 160 bend away from the door panel 100 such that the third set of walls 160 is parallel to the first set of walls 154.

When door panel 100 is in the open position, weather strips 132 and 134 do not make contact with sill 112 or header 136. This noncontact of the weather strips 132 and 134 with sill 112 and header 136 reduces the force 128 needed to move the door panel 100. This is in contrast with weather stripping that is secured to a sliding door panel and always in contact with the sill and/or header. Weather stripping that is in continued contact between the sliding door and the sill and/or header provides a frictional force that must be overcome by a user when the sliding door is moved.

When door panel is in the open position and moved to the closed position, the first set of rollers 104 reaches the bottom corner 164 of the first ramp 114. At the same moment, the second set of rollers 106 reaches the bottom corner 170 of the second ramp 116. The first set of rollers 104 proceeds up the angled portion 118 of the first ramp 114. The second set of rollers 106 also proceeds of the angled portion 122 of the second ramp 116. The first set of rollers 104 reaches the top horizontal portion 176 of the first ramp 114 at the same time the second set of rollers 106 reaches the top horizontal position 178 of the second ramp 116.

When both sets of rollers 104, 106 reach their respective positions on the horizontal portions 176, 178 of each ramp 114, 116, weather stripping 132 and 134 make contact with sill 112 and header 136 respectively. In the fully closed position, weather stripping 132 and 134 are compressed forming a weather tight seal between sliding door panel 100 and sill 112 and header 136. In one embodiment, weather strips 132 and 134 move from a non-compressed state when door panel 100 is in the fully open position to a compressed state when door is in the raised position on horizontal portions 176 and 178 of ramp 114 and ramp 116 respectively. In one embodiment, weather strips 132 and 134 become increasingly compressed as door panel 100 is moved up inclined surfaces 118 and 122 of ramps 114 and 116 respectively. In a further optional implantation horizontal portions 176, 178 may include a concave portions (not shown) to allow rollers to be located therein. The concave portions facing downward toward the earth for sill 112 would assist in door panel 100 in moving to the fully closed position in which a vertical edge of door panel 100 would be closely adjacent a vertical jamb of a sliding door frame or opening in the architectural opening.

In one embodiment, weather strips 132 and 134 are made of a material that is pliable. The weather strips 132, 134 must be able to provide enough flexibility to provide a weather-resistant seal around the door panel 100 when the door panel 100 is closed. The weather strips 132, 134 must also be able to decompress and/or return to their original shape when the door panel 100 is opened. In another embodiment, weather strips 132, 134 are not pliable but include a hinged portion that is biased outward from the door toward the header or sill when attached to the door, or biases outwardly toward the door when attached to the header or sill.

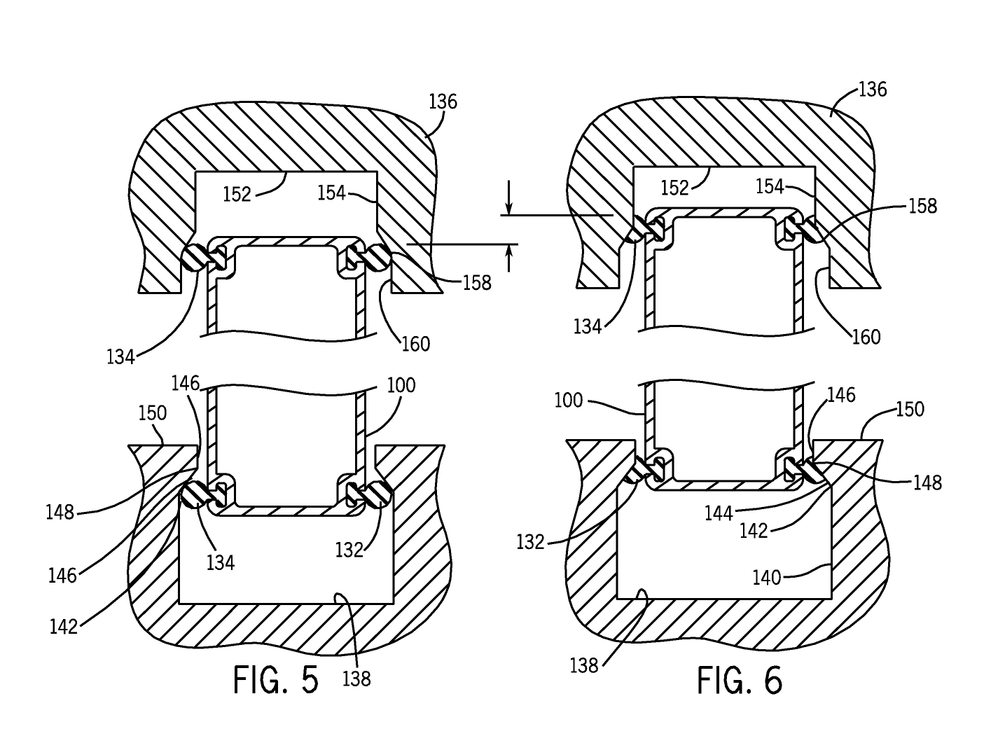

In the embodiment without the beads 180, FIG. 3 shows the weather strips 132, 134 attached to the door panel 100. The beads 180 and the weather strips 132, 134 are in a non-interference mode when the door panel 100 is open. FIG. 4 shows the weather strips 132, 134 in a compressed and sealed mode when the door panel 100 is closed. FIG. 5 shows a close-up view of FIG. 3 showing the non-interference of the door panel 100 with the weather strips 132, 134. FIG. 6 shows a close-up view of FIG. 4 showing the door panel 100 making a compressed contact with the weather strips 132, 134. By designing the door panel 100 to only make contact with the weather strips 132, 134 just prior to closing, the amount of weather strip compression can be increased and thereby increasing the door panels 100 ability to resist air and water infiltration. In one embodiment, weather strips 132 and 134 may be in nominal first contact state with sill 112 and header 136 when door panel 100 is in the open position. The nominal first contact state provides for weather strips 132 and 134 to gently contact sill 112 and header 136. In this embodiment, weather strips 132 and 134 are in an increased second contact state with sill 112 and header 136 when door panel 100 is in the raised and closed position. The increased second contact state provides for a greater seal between door panel 100 and sill 112 and header 136. In one embodiment weather strips 132 and 134 are more compressed in the increased second contact state then in the first nominal contact state.

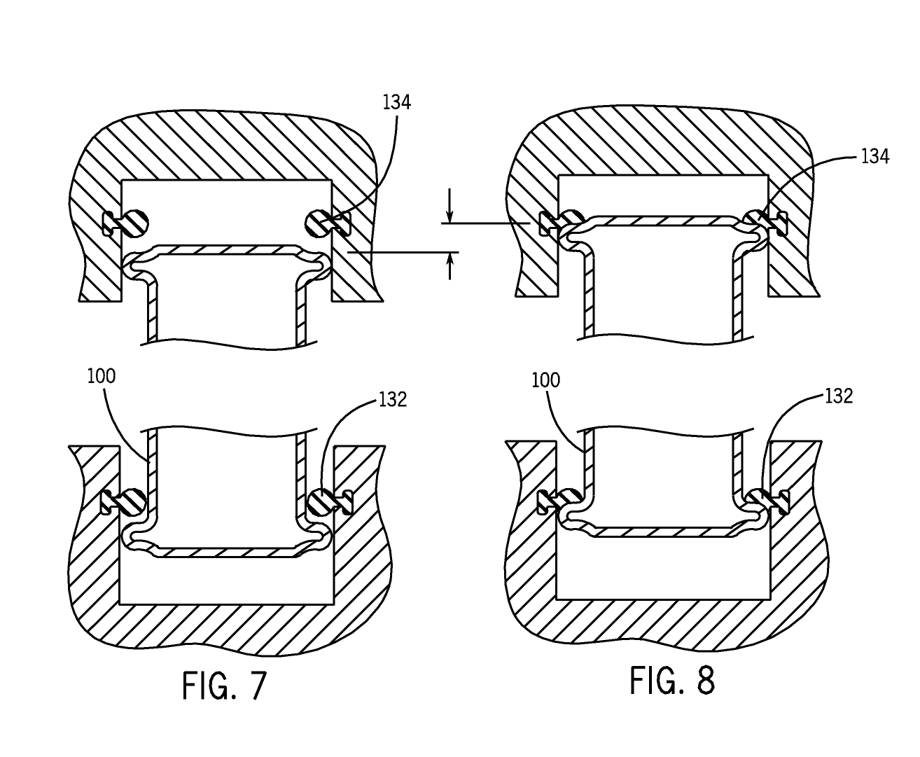

Referring to FIGS. 7 and 8 an alternative embodiment includes weather stripping secured to the sill and header. Beads 180 are secured to or part of door panel 100 that engage the weather stripping on the sill and header when the door panel 100 is in the raised and closed position. FIGS. 7 and 8 show the weather strips 132, 134 attached to the sill 112 and the header 136. Weather strips 132, 134 are made of a material that is pliable. Bead 180s engage and provide a seal with weather strips 132, 134 when the door panel 100 is closed. Weather strips 132, 134 must also be able to decompress to its original shape when the door panel 100 is opened. FIG. 7 shows weather strips 132, 134 in a non-interference mode when the door is open. FIG. 8 shows the weather strips 132, 135 in a compressed and sealed mode when the door panel 100 is closed. By designing the beads 180 to only make contact with the weather strips 132, 134 as prior to closing, the amount of weather strip compression can be increased thereby increasing the seal between door panels 100 and sill 112 and/or header 136 to resist air and water infiltration.

As an option, the door panel 100 also includes self-latching handle hardware 182. The handle latch hardware 182 will automatically latch the door panel 100 when the door panel 100 reaches the final closed position as shown in FIG. 2. By automatically latching the sliding door when the sliding door is moved to a closed position. A sliding door may bounce from the closed to the open position, when a sliding door is closed and first hits the door jamb. An automatically latching feature would provide the benefit of avoiding the bounce effect. Additionally, an automatically latch feature would act to capture any potential energy from the weather stripping in the jamb and/or in the header and sill that may provide a force to open the door in the engaged position. An automatic latching feature requires no further action to latch the sliding door by a user other than sliding the door panel 100 to the fully closed position. Once the sliding door is latched the door panel 100 may be locked prohibiting the sliding door from being opened from an exterior of the building or room. Further if the sliding door is latched it will be easier for a user to lock and will require less force 128 to engage the handle lock hardware 182. Locking the door panel 100 normally moves the operating panel into the frame jamb 184 such that the weather strips 132, 134 can be compressed for sealing which adds force to the lock lever 186. It is noted that the term latch as used herein activates a latch to hold the sliding door in a closed position but does not lock the door which would prohibit a user to open the door from an exterior of the sliding door without a lock.

The door panel 100 can easily be opened by lifting or rotating the door handle 130 and applying a force in a vector direction 188 in the opposite direction of closing the door panel 100. Referring to FIG. 1 the force that is applied to the door handle 130 would be horizontally to the left. As explained further below, after traveling a small distance, the door panel 100 disengages from the weather strips 132, 134. This disengagement from the weather strips 132, 134 will allow the door panel to open with less force than if the door panel 100 was making contact with the weather strips 132, 134.

The first set of rollers 104 will leave the top surface 176 of the first ramp 114 and move down the angle inclined 172. At the same time, the second set of rollers 106 will move from the top surface 178 of the second ramp 116 and move down the angled surface 174 of the second ramp 116. Having both sets of rollers 104, 106 travel down their respective ramps 114, 116 thereby utilizing the potential energy that was stored when the door panel 100 was moved to the raised and closed position. The use of the potential energy reduces the force required to open the door panel 100 as compared to the force required to open door panel 100 if it had not been in a raised position. Further, once the rollers 104, 106 begin travel down their respective angle portions 172, 174, the door panel 100 the weather strips 132, 134, are no longer engaging the sill and header in one embodiment thereby further reducing the amount of force required to move the sliding door from the closed to open positions. Similarly in the alternative embodiment, in which weather strips 132, 134 are operatively connected to sill 112 and header 136, as door panel 100 moves down the inclined surfaces of ramps 114 and 116, weather strips 132, 134 disengage from door panel 100 either directly or via a bead 180 or other features secured to door panel 100. As the weather strips 132, 134 either disengage from door panel 100 completely or partially, weather strips 132, 134 will exert a reduced frictional force between the door panel 100 and sill 112 and header 136 thereby making the reducing the force 188 required to move the door panel 100 from the closed position to the fully open position.

The term disengage is used herein to include decompression of weather strips from a compressed state to a less compressed state including a completely non-compressed state. It may be desirable to have the weather strips in contact with the door and header or sill throughout the distance the door may travel from the door jamb in a less compressed state than when the door is in the fully closed position. In the case of the hinged type of weather strip that do not have a pliable portion but rather include a spring biased portion that engages the door and/or the header and sill, the term disengage means that the spring biased hinge portion of the weather strip is in a more extended position than when engaged. Stated another way, the hinged biased portion forms an angle with the portion to which it is hinged that is greater in the disengaged position than in the engaged position. When the hinged portion of a hinged type weather strip is engaged it is biased toward the portion to which it is hinged.

When a user moves door panel 100 from the open to closed position door panel has inertia that assists in moving door panel 100 to the raised position on the ramps. In one embodiment, weather stripping is provided in the vertical jamb that receives the vertical edge of door panel 100. By way of clarification, the vertical edge of door panel 100 is the side of the door that faces the vertical jamb and is perpendicular to the sill and header. The weather stripping in the vertical jamb (not shown) is compressed as door panel 100 is moved to the fully closed position. The inertia of the moving door panel 100 from the open position to the closed position assists in compressing the weather stripping in the vertical jamb. In one embodiment, an automatic latch is provided that latches door panel 100 to the vertical jamb once door panel 100 is in the fully closed position. The automatic latch prevents the compression of the weather stripping in the vertical jamb from being lost. The potential energy stored in the weather strip releases when the latch of door panel 100 is unlatched from the vertical jamb. The potential energy and the downhill slope of the ramps in the roller track reduces the breakaway force required to start the door panel moving from the closed position to the open position.

The previous embodiment is only one example for this apparatus. The apparatus can also be applied to windows, whether they open horizontally or vertically. The apparatus may be applied in general to any sliding fixture that appreciates low force movement, which only seals when in a closed position. In an embodiment in which ramps are used to bias a vertically moving window panel, the window may be biased from a first vertical rail or stile toward the second vertical rail or stile. Alternatively, a window may be biased from an outside orientation toward an inside orientation or from an inside orientation toward an outside orientation as the window is moved vertically from an open to closed position in order to engage weather stripping with the vertically moving window. The term rail as used herein may refer to either a horizontal or vertical positioned rail unless otherwise stated.

It is important to note that the construction and arrangement of the sliding door with ramp mechanism as described herein is illustrative only. Although only a few embodiments of the present invention have been described in detail in this disclosure, those skilled in the art who review this disclosure will readily appreciate that many modifications are possible (e.g. variations in sizes, dimensions, structures, shapes and proportions of the various elements, values of parameters, mounting arrangements, use of materials, colors, orientations, etc.) without materially departing from the novel teachings and advantages of the subject matter recited in the claims. For example, elements shown as integrally formed may be constructed of multiple parts or elements and vice versa, the position of elements may be reversed or otherwise varied, and the nature of number of discrete elements or positions may be altered or varied. Additionally, the apparatus may also be applied to sliding windows, whether they open horizontally or vertically. The apparatus may be applied in general to any sliding fixture where a reduced force is appreciated when opening the fixture and/or when a greater seal is desired when the sliding fixture is in the closed position than when in the open position. Accordingly, all such modifications are intended to be included within the scope of the present invention to be included within the scope of the present invention as defined in the appended claims. The order or sequence of any process or method steps may be varied or re-sequenced according to alternative embodiments. Other substitutions, modifications, changes and omissions may be made in the design, operating conditions and arrangement of the exemplary embodiments without departing from the scope of the present inventions as expressed in the appended claims.

1. A sliding door comprising:
a sliding door including a slidable panel;
a first weather stripping member secured to a portion of the slidable panel;
a header; and
a sill including a track having a length defining a longitudinal axis, the track including a first ramp and a second ramp spaced from the first ramp along the longitudinal axis;
the slidable panel moving along the longitudinal axis from an open position to a closed position, the slidable panel being moved from a lowered position to a raised position on both the first ramp and second ramp when the slidable panel is moved to and in the closed position,
the first weather stripping member being engaged against one of either the header and sill when the slidable panel is in the raised and closed position, and the first weather stripping member being disengaged from the one of the header and sill when the slidable panel is the lowered and open position.

2. The sliding door of claim 1, wherein the first weather stripping member is secured to a bottom portion of the slidable panel and a second weather stripping member is secured to a top portion of the sliding panel, the sill including an engagement member that engages the first weather stripping member and the header including an engagement member that engages the second weather stripping member when the sliding panel is in the raised position.

3. The sliding door apparatus of claim 2, wherein the slidable panel in the raised position on the ramps has potential energy to aid in opening the sliding door.

4. The sliding door of claim 2, wherein the sill includes a lower portion and a first raised wall and a second raised wall extending from the lower portion of the sill toward the header, the engagement member of the sill extending from the first raised wall, the engagement member of the sill extending inwardly toward the second raised wall.

5. The sliding door of claim 4, the sill further including a second engagement member extending from the second raised wall and inwardly toward the first raised wall, a third weather stripping member extends from the lower portion of the sliding door in a direction opposite the first weather stripping member, wherein the first engagement member engages the first weather stripping member when the second engagement member engages the third weather stripping member.

6. The sliding door of claim 4, wherein the first raised wall is a first distance from the second raised wall, and the first weather stripping member is a second distance from the third weather stripping member; the second distance being less than the first distance, when the first weather stripping member and third weather stripping member is disengaged with the first engagement member and the second engagement member respectively.

7. The apparatus of claim 1, wherein the first engagement member and second engagement member respectively contacts the first weather stripping and third weather stripping when the sliding panel is in the closed position more than when the sliding panel is in the open position.

8. The apparatus of claim 1, wherein the opening of the sliding panel disengages the the weather stripping member from the one of the sill and header as the sliding panel is lowered from the ramps, thereby reducing the force necessary to open the door.

9. A sliding barrier apparatus comprising:
a barrier including a sliding panel,
a first weather strip and a second weather strip,
a first rail and a second rail spaced from and parallel with the first rail,
the sliding panel including a first side and a second side sliding respectively within the first rail and second rail,
the first rail including a longitudinal axis and having a first incline and a second incline spaced apart from the first incline along the longitudinal axis, each of the first incline and second incline having a raised portion extending toward the second rail,
wherein the sliding panel slides within the first rail and second rail from an open position to a closed position, the sliding panel being on the raised portions when the sliding panel is in the closed position.

10. The apparatus of claim 9, wherein the barrier is a door or a window.

11. The apparatus of claim 9, wherein the apparatus includes a first set of guiding rollers and a second set of guiding rollers.

12. The apparatus of claim 11, wherein the sliding panel makes more contact with each weather strip in the closed position than in the open position, thereby reducing a force necessary to open the barrier.

13. The apparatus of claim 12, wherein the first set of guiding rollers shift from the first rail to the first incline and the second set of guiding rollers shift from the first rail to the second incline as the sliding panel moves to the closed position such that the set of guiding rollers rests on its respective raised portion, thereby putting the sliding panel in the closed position.

14. The apparatus of claim 13, wherein there is sufficient flexibility in each weather strip to compress without damage thereby creating a seal between the sliding panel and each of the first and second rails.

15. The apparatus of claim 13, wherein the sliding panel gains potential energy when the sliding panel is on the raised portions.

16. The apparatus of claim 12, wherein the first set of guiding rollers shift from the first incline to the first rail and the second set of guiding rollers shift from the second incline to the first rail, thereby putting the sliding panel in the open position.

17. (canceled)

18. The apparatus of claim 16, wherein the sliding panel uses gravity as an addition force to move the sliding panel toward the open position.

19. A method for moving a slidable panel, comprising:
providing the slidable panel having a first weather stripping member secured to a portion of the slidable panel;
providing a sill including a track having a length defining a longitudinal axis, the track including a first ramp and a second ramp spaced from the first ramp along the longitudinal axis;
sliding the slidable panel along the longitudinal axis from an open position to a closed position, the slidable panel being moved from a lowered position to a raised position on both the first ramp and second ramp as the slidable panel is moved to the closed position; and
engaging the weather stripping against at least one of either a header and sill when the slidable panel is in the raised and closed position.

20. The method for moving a slidable panel of claim 19, further including
sliding the slidable panel along the longitudinal axis and moving the slidable panel from off of the first ramp and second ramp as the slidable panel is moved from the closed position to an open position; and
disengaging the weather stripping from the header or sill when the slidable panel is moved from the open position to the closed position.
